(19) United States
(12) Patent Application Publication
(10) Pub. No.: US 2015/0122111 A1
(43) Pub. Date: May 7, 2015

(54) ADAPTER FOR MUSIC DEVICES

(71) Applicants: Jory Bell, San Francisco, CA (US); Joshua Pollack, San Francisco, CA (US); Yurichiro Kuzuryu, Foster City, CA (US)

(72) Inventors: Jory Bell, San Francisco, CA (US); Joshua Pollack, San Francisco, CA (US); Yurichiro Kuzuryu, Foster City, CA (US)

(73) Assignee: MISELU INC, San Francisco, CA (US)

(21) Appl. No.: 14/070,559

(22) Filed: Nov. 3, 2013

(51) Int. Cl. G10H 1/00

(52) U.S. Cl. CPC G10H 1/0066
USPC 84/645

(57) ABSTRACT

Embodiments generally relate to an adapter device for music devices. In one embodiment, an adapter includes an adapter body. The adapter further includes a connector for communicating with a music device. The adapter further includes a module for communicating wirelessly.

### BACKGROUND

The creation of music is a popular activity enjoyed by many people. Various musical instrument devices and music applications enable a user to create music. Such devices and applications provide sounds that emulate the sounds of musical instruments. For example, a keyboard with piano keys when pressed may make piano sounds. In some scenarios, users may combine two or more music devices in order to create or modify music.

### SUMMARY

Embodiments generally relate to an adapter device for music devices. In one embodiment, an adapter includes an adapter body. The adapter further includes a connector for communicating with a music device. The adapter further includes a module for communicating wirelessly.

In another embodiment, a system includes one or more processors. The system further includes. The system further includes logic encoded in one or more tangible media for execution by the one or more processors, and when executed operable to perform operations including enabling an adapter to communicate with a music device. The logic when executed is further operable to perform operations including enabling the adapter to communicate wirelessly.

In another embodiment, a method includes providing an adapter for communicating with a plurality of devices. The method further includes enabling the adapter to communicate with a music device. The method further includes enabling the adapter to communicate wirelessly.

### BRIEF DESCRIPTION OF THE DRAWINGS

FIG. 1 is a top-view diagram of an example adapter for music devices, which may be used to implement the embodiments described herein.

FIG. 2 is a sectional top-view diagram of an example adapter for music devices, which may be used to implement the embodiments described herein.

FIG. 3 is a sectional side-view diagram of an example adapter for music devices, which may be used to implement the embodiments described herein.

FIG. 4 is a block diagram of an example system, which may be used to implement the embodiments described herein.

FIG. 5 illustrates an example simplified flow diagram for providing an adapter for music devices, according to some embodiments.

### DETAILED DESCRIPTION OF EMBODIMENTS

Embodiments generally relate to an adapter for music devices. In various embodiments, the adapter includes an adapter body, a connector for communicating with a music device, and a module for communicating wirelessly. In various embodiments, the connector is a musical instrument digital interface (MIDI) connector, and the module for communicating wirelessly is a Bluetooth module. In various embodiments, the adapter includes a switch that controls the direction of information transmission at the adapter, where the switch toggles between an input mode and an output mode. The switch enables a user to select between the input mode and the output mode.

As a result, the user has more flexibility combining two or more music devices in order to create or modify music.

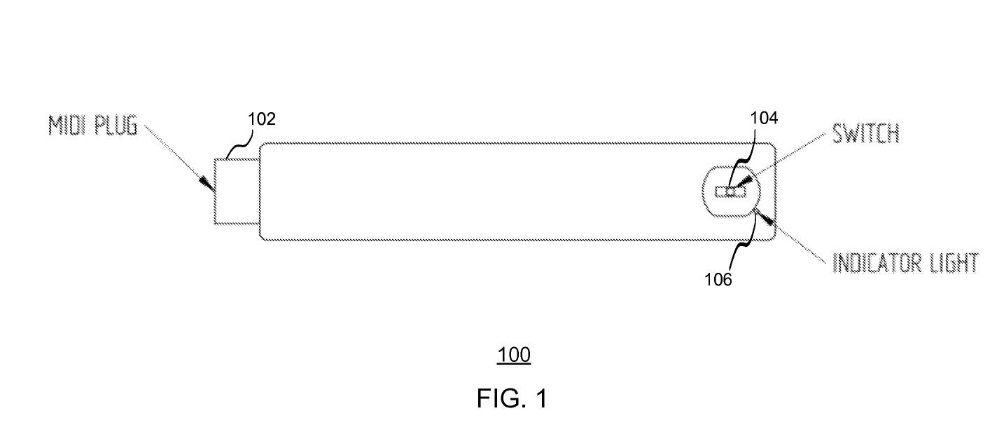

FIG. 1 is a top-view diagram of an example adapter 100 for music devices, which may be used to implement the embodiments described herein. As shown, adapter 100 includes an adapter body that houses a connector for communicating with a music device. In various embodiments, the connector for communicating with a music device is a MIDI plug or MIDI connector 102. As shown, adapter 100 also includes a switch 104 and an indicator light 106.

In various embodiments, MIDI connector 102 connects to a music device. In various embodiments, the music device may be musical instrument (e.g., piano, keyboard, synthesizer, drum machine, etc.), controller (e.g., drum and percussion controllers, stringed instrument controllers, performance controllers, etc.), etc.

In various embodiments, MIDI connector 102 includes an input circuit and an output circuit (not shown). In some embodiments, the input circuit enables MIDI connector 102 to provide information to an input of a music device. In some embodiments, the output circuit enables MIDI connector 102 to receive information from an output of a music device.

In various embodiments, switch 104 controls the direction of information transmission at the adapter. In various embodiments, switch 104 toggles adapter 100 between difference modes. For example, switch 104 may toggle adapter 100 to an input mode, where adapter 100 receives information wirelessly from one or more devices (e.g., computer, table computer, etc.) and feeds the information to a music device via MIDI connector 102.

In another example, switch 104 may toggle adapter 100 to an output mode, where adapter 100 receives information from a music device via MIDI connector 102 and transmits out the information wirelessly to other devices (e.g., computer, table computer, etc.).

In various embodiments, the information transmitted via adapter 100 may include various MIDI messages that specify sound related information such as notation, pitch, velocity, control signals, etc. Such control signals may include parameters such as volume, cues, audio panning, vibrato, etc. Control signals may also include clock signals, which set and synchronize tempo between various devices.

In various embodiments, indicator light 106 may indicate various states and/or activities. For example, in some embodiments, indicator light 106 may indicate that adapter 100 is processing information (e.g., receiving information, sending information, etc.). In some embodiments, indicator light 106 may indicate that adapter 100 is connected to a music device via MIDI connector 102.

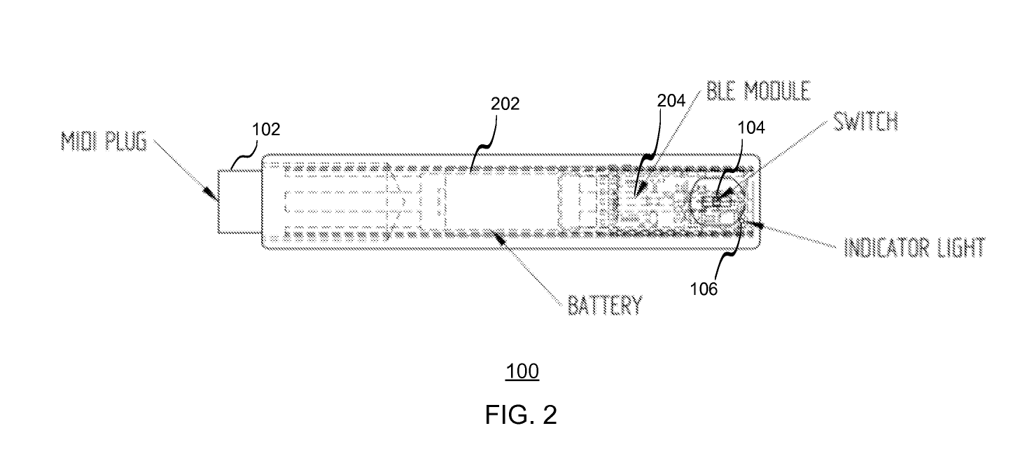

FIG. 2 is a sectional top-view diagram of adapter 100, which may be used to implement the embodiments described herein. As shown, adapter 100 includes MIDI connector 102, switch 104, and indicator light 106. In some embodiments, adapter 100 may include a battery 202.

In various embodiments, adapter 100 includes a module for communicating wirelessly. In some embodiments, the module for communicating wirelessly is a Bluetooth module 204. In some embodiments, Bluetooth module 204 may be a Bluetooth low energy module.

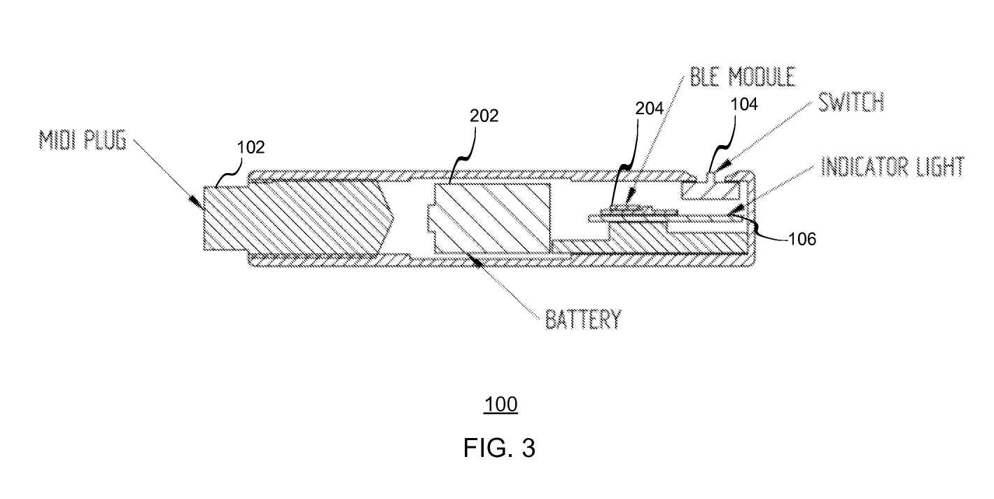

FIG. 3 is a sectional side-view diagram of adapter 100, which may be used to implement the embodiments described herein. As shown, adapter 100 includes MIDI connector 102, switch 104, indicator light 106, battery 202, and Bluetooth module 204.

In various embodiments, adapter 100 may also include other connectors. For example, in some embodiments, adapter 100 may also include a universal serial bus (USB) connector (not shown). In some embodiments, such a USB connector may be positioned at one end of adapter 100 at the opposite end from MIDI connector 102. In other words, referring to FIG. 3, while MIDI connector 102 is located at one end of adapter 100 (e.g., far left end), a USB connector may be located at the opposite end of adapter 100 (e.g., far right end).

In some embodiments, a USB connector on adapter 100 may have a variety of different functions. For example, the USB connector may provide power to adapter 100. As such, if adapter 100 receives power via a USB connector, adapter 100 could operative without the need for battery 202. In some embodiments, adapter 100 may be powered via a USB connector when a device such as a computer, tablet computer, etc., is available to provide power via the USB connector. Adapter 100 may alternatively be powered by battery 202 whenever a device is not available to provide power to adapter 100 via the USB connector.

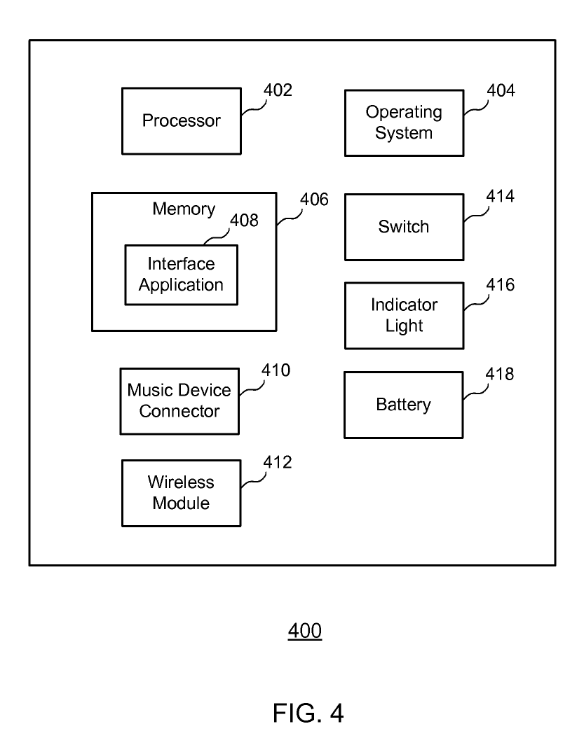

FIG. 4 is a block diagram of an example system 400, which may be used to implement the embodiments described herein. In some embodiments, system 400 may include a processor 402, an operating system 404, a memory 406, an interface application 408, a music device connector 410, a wireless module 412, a switch 414, an indicator light 416, and a battery 418. In various embodiments, music device connector 410 may represent MIDI connector 102 of FIG. 1, switch 414 may represent switch 104 of FIG. 1, indicator light 416 may represent indicator light 106 of FIG. 1. Also, battery 418 may represent battery 202 of FIG. 2, and wireless module 412 may represent Bluetooth module 204 of FIG. 2

For ease of illustration, the blocks shown in FIG. 4 are shown as individual units. In various embodiments, these blocks may each represent multiple units. In other embodiments, system 400 may not have all of the components shown and/or may have other elements including other types of elements instead of, or in addition to, those shown herein.

In various embodiments, processor 402 may be any suitable processor or controller (e.g., an embedded processor, a central processing unit (CPU), a general-purpose microprocessor, a microcontroller, a microprocessor, etc.). Further, operating system 404 may be any suitable operating system (OS), or mobile OS/platform, and may be utilized to manage operation of processor 402, as well as execution of various application software. Examples of operating systems include Android from Google, iPhone OS (iOS), Berkeley software distribution (BSD), Linux, Mac OS X, Microsoft Windows, and UNIX.

In various embodiments, memory 406 may be used for instruction and/or data memory, as well as to store music and/or video files created on or downloaded to system 400. Memory 406 may be implemented in one or more of any number of suitable types of memory (e.g., static random access memory (SRAM), dynamic RAM (DRAM), electrically erasable programmable read-only memory (EEPROM), etc.). Memory 406 may also include or be combined with removable memory, such as memory sticks (e.g., using flash memory), storage discs (e.g., compact discs, digital video discs (DVDs), Blu-ray discs, etc.), and the like. Interfaces to memory 406 for such removable memory may include a universal serial bus (USB), and may be implemented in adapter 100.

Interface application 408 may be stored on memory 406 or on any other suitable storage location or computer-readable medium. In various embodiments, interface application 408 provides instructions that enable processor 402 to perform the functions described herein.

As indicated herein, music device connector 410 is operable to communicate with a music device. In various embodiments, music device connector 410 may be a MIDI connector. In various embodiments, wireless module 412 is used for wireless connectivity (e.g., Wi-Fi, Bluetooth, etc.) to the Internet (e.g., navigable via touchscreen), or to another device. In various embodiments, wireless module 412 is a Bluetooth module. In some embodiments, wireless module 412 is a Bluetooth low energy module.

In some implementations, system 400 may include a USB interface (not shown) to connect with any USB-based device. As indicated herein, such a USB interface may also function to connect with another device (e.g., to transmit and/or receive information, to provide power to adapter 100, etc.).

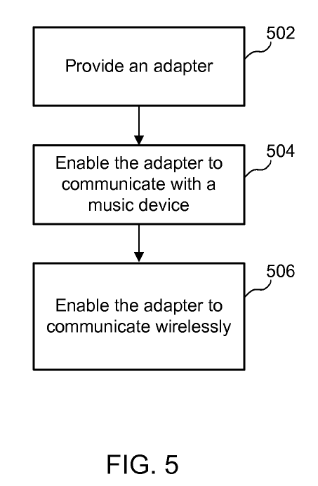

FIG. 5 illustrates an example simplified flow diagram for providing an adapter for music devices, according to some embodiments. Referring to both FIGS. 4 and 5, a method is initiated in block 502 where an adapter is provided for communicating with multiple devices.

In block 504, system 400 enables the adapter to communicate with a music device. As indicated herein, a MIDI connector enables the adapter to communicate with a music device. As indicated herein, switch 414 controls the direction of information transmission at the adapter. In some embodiments, switch 414 enables a user to select the direction of information transmission at the adapter, where switch 414 toggles between an input mode and an output mode.

In block 506, system 400 enables the adapter to communicate wirelessly. As indicated herein, the adapter may be enabled to communicate wirelessly using a Bluetooth module. In various embodiments, the Bluetooth module may be a Bluetooth low energy module.

Embodiments described herein facilitates a user to enjoy a music playing experience by enabling a user to conveniently combine two or more music devices. As a result, the user has more flexibility combining various music devices in order to create or modify music.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. An adapter comprising:
an adapter body;
a connector for communicating with a music device; and
a module for communicating wirelessly.

2. The adapter of claim 1, wherein the connector is a musical instrument digital interface (MIDI) connector.

3. The adapter of claim 1, further comprising a switch that controls a direction of information transmission at the adapter.

4. The adapter of claim 1, further comprising a switch that controls a direction of information transmission at the adapter, wherein the switch toggles between an input mode and an output mode.

5. The adapter of claim 1, wherein the module is a Bluetooth module.

6. The adapter of claim 1, wherein the module is a Bluetooth low energy module.

7. The adapter of claim 1, further comprising a universal serial bus connector.

8. A system comprising:
one or more processors; and
logic encoded in one or more tangible media for execution by the one or more processors, and when executed operable to perform operations comprising:
enabling an adapter to communicate with a music device; and
enabling the adapter to communicate wirelessly.

9. The system of claim 8, wherein, to enable the adapter to communicate with the music device, the logic when executed is further operable to perform operations comprising enabling communication through a musical instrument digital interface (MIDI) connector.

10. The system of claim 8, wherein the logic when executed is further operable to perform operations comprising enabling a switch to control a direction of information transmission at the adapter.

11. The system of claim 8, wherein the logic when executed is further operable to perform operations comprising enabling a user to select a direction of information transmission at the adapter.

12. The system of claim 8, wherein the logic when executed is further operable to perform operations comprising enabling a user to select a direction of information transmission at the adapter using a switch, and wherein the switch toggles between an input mode and an output mode.

13. The system of claim 8, wherein, to enable the adapter to communicate wirelessly, the logic when executed is further operable to perform operations comprising enabling communication through a Bluetooth module.

14. A method comprising:
providing an adapter for communicating with a plurality of devices;
enabling the adapter to communicate with a music device; and
enabling the adapter to communicate wirelessly.

15. The method of claim 14, wherein the enabling of the adapter to communicate with the music device comprises providing a musical instrument digital interface (MIDI) connector.

16. The method of claim 14, wherein the enabling of the adapter to communicate with the music device comprises providing a switch that controls a direction of information transmission at the adapter.

17. The method of claim 14, further comprising enabling a user to select a direction of information transmission at the adapter.

18. The method of claim 14, further comprising enabling a user to select a direction of information transmission at the adapter by providing a switch, wherein the switch toggles between an input mode and an output mode.

19. The method of claim 14, wherein the enabling of the adapter to communicate wirelessly comprises providing a Bluetooth module.

20. The method of claim 14, wherein the enabling of the adapter to communicate wirelessly comprises providing a Bluetooth module, wherein the Bluetooth module is a Bluetooth low energy module.
